(19) United States
(12) Patent Application Publication
(10) Pub. No.: US 2022/0227184 A1
(43) Pub. Date: Jul. 21, 2022

(54) PNEUMATIC TIRE AND METHOD OF MANUFACTURING PNEUMATIC TIRE

(71) Applicant: BRIDGESTONE CORPORATION, Tokyo (JP)

(72) Inventor: Hayato TODA, Chuo-ku, Tokyo (JP)

(73) Assignee: BRIDGESTONE CORPORATION, Tokyo (JP)

(21) Appl. No.: 17/596,285

(22) PCT Filed: Jun. 5, 2020
(86) PCT No.: PCT/JP2020/022379

§ 371 Date: Dec. 7, 2021

(30) Foreign Application Priority Data
Jun. 12, 2019 (JP) 2019-109532

(51) Int. Cl. B60C 19/00; B60C 5/00; B29D 30/00

(52) U.S. Cl. CPC B60C 19/00; B29D 2030/0072; B29D 30/0061; B60C 5/00

(57) ABSTRACT

A pneumatic tire includes at least one balance patch arranged on a tire inner surface that is a surface on the inner side of the tire, and a functional component having a communication function and arranged on the tire inner surface at a position separated at a predetermined angle θ from the balance patch in a tire circumferential direction.

### TECHNICAL FIELD

The present invention relates to a pneumatic tire and a method of manufacturing a pneumatic tire.

### BACKGROUND ART

Tires (particularly aircraft tires) are known that are provided with balance patches on the inner surface to adjust a weight balance of the tires (Patent Literature 1). A balance patch disclosed in Patent Literature 1 has a flat sheet-like shape, and is attached to the inner surface of the tire with an adhesive. The balance patch disclosed in Patent Literature 1 is used such that the entire surface of the balance patch on one side is sticked to the inner surface of the tire, and thus has the following problems.

When a tire reused, a tread rubber of the spent tire is scraped off, and a new tread rubber is attached to the tire. The balance patch, when provided on the inner surface of the tire, is often temporarily removed and again attached to the inner surface of the tire so as to adjust the weight balance. Since the balance patch needs to be scraped off by use of a hand grinder and the like when removed, the scraping operation leads to a reduction in productivity of manufacturing retread tires. To deal with this, a technique is disclosed that provides a balance patch with a projection so as to facilitate the removal of the balance patch to save the time during the manufacture of retread tires (Patent Literature 2).

### CITATION LIST

### Patent Literature

Patent Literature 1: Japanese Unexamined Patent Application Publication No. 2012-121561
Patent Literature 1: Japanese Unexamined Patent Application Publication No. 2014-133504

### SUMMARY OF INVENTION

### Technical Problem

The demand for appropriate management of tires has grown according to information such as used situations or traveling distances of the tires acquired from a RFID tag (a functional component) attached to the inner surface of each tire. When both the balance patch and the RFID tag are attached to the inner surface of the tire, there is a risk of unintentionally causing damage to the RFID tag in the process of removing the balance patch during the manufacture of the retread tire. Patent Literature 2 does not mention this issue, which still needs to be improved.

To solve the conventional problems described above, the present invention provides a pneumatic tire and a method of manufacturing a pneumatic tire capable of preventing damage to a functional component in a process of removing a balance patch during the manufacture of a retread tire.

### Technical Solution

A pneumatic tire according to an aspect of the present invention includes at least one balance patch (balance patch 40) arranged on a tire inner surface (tire inner surface 30) that is a surface on an inner side of the tire (tire 10), and a functional component (functional component 50) having a communication function and arranged on the tire inner surface at a position separated at a predetermined angle (predetermined angle θ) from the at least one balance patch in a tire circumferential direction.

### Advantageous Effects

The present invention can prevent damage to the functional component.

### BRIEF DESCRIPTION OF DRAWINGS

FIG. 1 is a cross-sectional view taken along a width direction and a radial direction of a pneumatic tire.

FIG. 2 is a cross-sectional view taken along a circumferential direction of the pneumatic tire.

FIG. 3A is a perspective view illustrating a balance patch according to the present embodiment.

FIG. 3B is a perspective view illustrating a functional component according to the present embodiment.

FIG. 4 is a cross-sectional view taken along the circumferential direction of the pneumatic tire.

FIG. 5 is a cross-sectional view taken along the circumferential direction of the pneumatic tire.

FIG. 6 is a cross-sectional view taken along the circumferential direction of the pneumatic tire.

### DESCRIPTION OF EMBODIMENTS

Hereinafter, some embodiments according to the present invention are described with reference to the drawings. The same elements illustrated in the drawings are denoted by the same reference numerals, and overlapping explanations are not made below.

1. Configuration of Pneumatic Tire

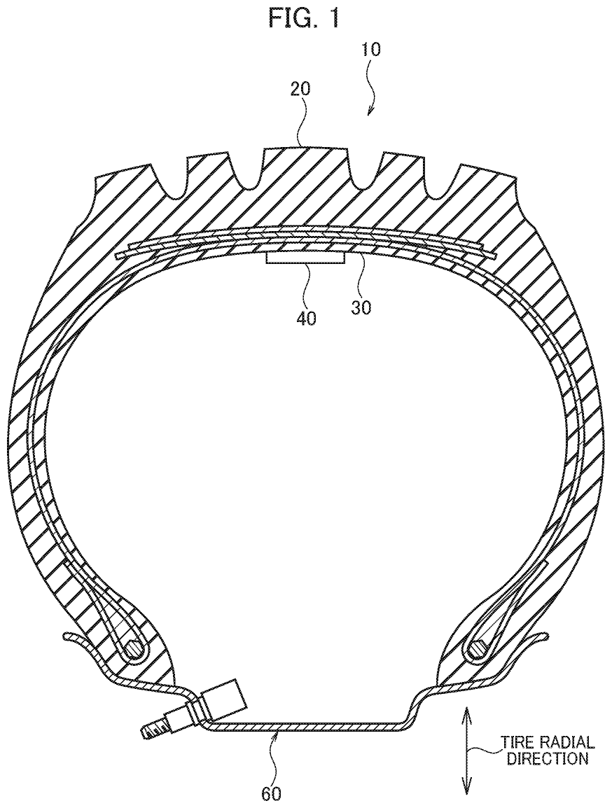

A configuration of a pneumatic tire 10 (referred to also simply as a “tire”) according to the present embodiment is described below with reference to FIG. 1.

As illustrated in FIG. 1, the tire 10 is used in a state of being attached to a rim hole 60. The inner space of the tire 10 attached to the rim hole 60 is filled with gas such as air. The tire 10 according to the present embodiment is illustrated with an aircraft tire mounted to an aircraft. The tire 10 is not limited to the use as the aircraft tire, and may be used for automobiles, trucks (including off-road dump trucks), and buses, for example.

A tread 20, which comes into contact with a road surface, is provided on the rear surface with a balance patch 40. The balance patch 40 is attached to the surface on the inner side of the tire 10, which is a tire inner surface 30. The balance patch 40 is a member used for improving uniformity of the tire 10, and is typically used for aircraft tires.

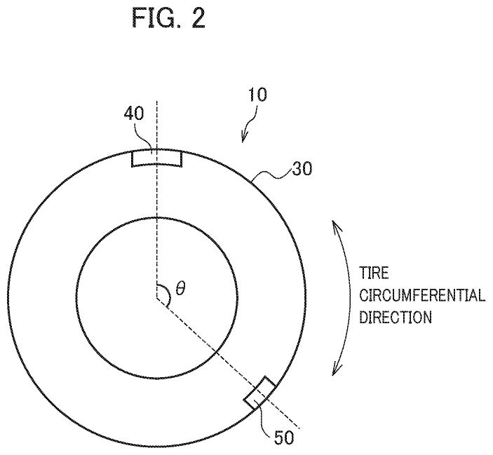

As illustrated in FIG. 2, the tire inner surface 30 is also provided with a functional component 50 in addition to the balance patch 40. The functional component 50 is attached to the tire inner surface 30 at a position separated at a predetermined angle θ from the balance patch 40 in the tire circumferential direction. The predetermined angle θ is 90 degrees or greater when the single balance patch 40 is attached to the tire inner surface 30.

A gap between the balance patch 40 and the functional component 50 in the tire circumferential direction is longer than a length of the balance patch 40 in the tire circumferential direction, as illustrated in FIG. 2.

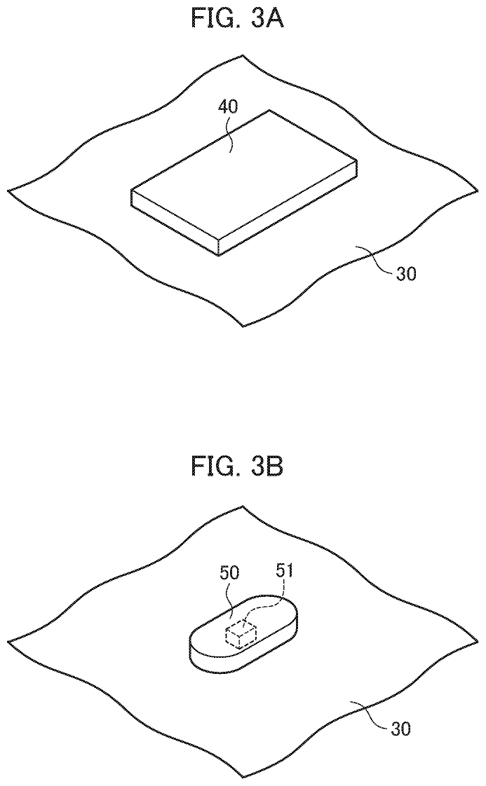

The balance patch 40 and the functional component 50 are described in more detail below with reference to FIG. 3A and FIG. 3B. As illustrated in FIG. 3A, the balance patch 40 has a flat sheet-like shape. The balance patch 40 is sticked to the tire inner surface 30 with an adhesive. The balance patch 40 is formed from a rubber composition having a large mass in view of the adjustment of the weight balance of the tire 10.

As illustrated in FIG. 3B, the functional component 50 has an oval shape. The functional component 50 has a configuration in which an electronic component such as a radio frequency identifier (RFID) tag 51 is covered with a rubber member. The material used for the functional component 50 is not limited to the rubber member, and may be a metal member or a resin member. The functional component 50 is also sticked to the tire inner surface 30 with an adhesive, as in the case of the balance patch 40. The balance patch 40 and the functional component 50 are both attached on the tire equator line.

The RFID tag 51 includes an antenna, and an IC chip having a communication function and operated by dielectric power generated by weak radio waves received by the antenna. The RFID tag 51 stores data on used conditions and traveling distances of aircraft tires, for example. The data stored in the RFID tag 51 is read out by use of a reader/writer, and is used for the management of the aircraft tires.

As illustrated in FIG. 3A and FIG. 3B, the functional component 50 is shorter in the tire circumferential direction and lighter than the balance patch 40 when attached.

The functional component 50 is attached to the tire inner surface 30 after the attachment of the balance patch 40.

2. Operational Effects

The operations and effects of the tire 10 are described below.

According to the present embodiment, at least one balance patch 40 is arranged on the tire inner surface 30 that is the surface on the inner side of the tire 10. The functional component 50 having the communication function is arranged on the tire inner surface 30 at a position separated at the predetermined angle θ from the balance patch 40 in the tire circumferential direction. The predetermined angle θ is 90 degrees or greater when the single balance patch 40 is provided (refer to FIG. 2). The arrangement of the balance patch 40 and the functional component 50 separated from each other at 90 degrees or greater in the tire circumferential direction avoids unintentional damage to the functional component 50 in the process of removing the balance patch 40 during the manufacture of the retread tire. This prevents the functional component 50 from being broken up accordingly.

The balance patch 40 provided for adjusting the weight balance of the tire 10 inevitably makes the circumference around the arrangement position slightly heavier. According to the present embodiment, the arrangement of the smaller and lighter functional component 50 than the balance patch 40 separated from each other at 90 degrees or greater in the tire circumferential direction can improve the uniformity of the tire 10.

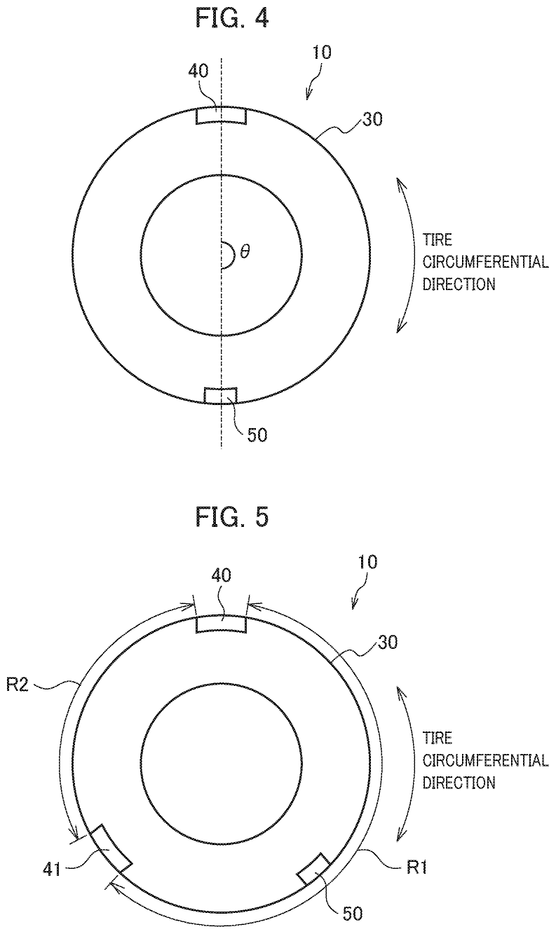

The functional component 50 may be arranged at a position separated from the balance patch 40 at 180 degrees in the tire circumferential direction, as illustrated in FIG. 4. This arrangement leads the functional component 50 to be located at a position furthest from the balance patch 40, so as to prevent damage to the functional component 50 and improve the uniformity of the tire 10.

As illustrated in FIG. 5, two balance patches (balance patches 40 and 41) may be provided. The functional component 50 in this case only needs to be arranged in a region having a wider gap between the balance patch 40 and the balance patch 41 in the tire circumferential direction. FIG. 5 illustrates the case in which the balance patch 40 and the balance patch 41 define two gaps (regions R1 and R2) in the tire circumferential direction. The functional component 50 is thus led to be arranged in the region R1 wider than the region R2. This arrangement can also achieve the same effects as described above.

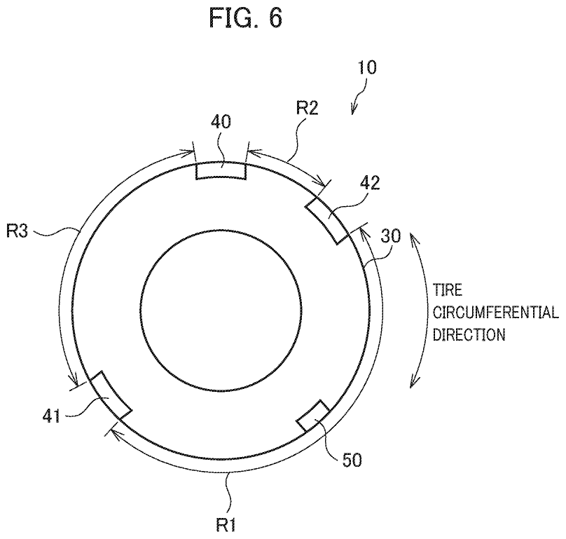

As illustrated in FIG. 6, three balance patches (balance patches 40 to 42) may be provided. The functional component 50 in this case only needs to be arranged in a region having the widest gap between the balance patches in the tire circumferential direction. FIG. 6 illustrates the case in which the respective balance patches define three gaps (regions R1 to R3) in the tire circumferential direction. The functional component 50 is thus led to be arranged in the region R1 wider than the region R2 and the region R3. This arrangement can also achieve the same effects as described above.

When the two or more balance patches are provided, as illustrated in FIG. 5 and FIG. 6, the predetermined angle θ between the functional component 50 and the respective balance patches is not necessarily 90 degrees or greater, and may be set to be less than 90 degrees. The angle between the functional component 50 and the respective balance patches is, however, preferably set to be larger in view of the prevention of damage to the functional component 50.

The tire 10 according to the present embodiment is manufactured by the process described below. At least the single balance patch 40 is attached to the tire inner surface 30, and the functional component 50 is then attached to the tire inner surface 30 at a position separated at the predetermined angle from the balance patch 40 in the circumferential direction, so as to manufacture the tire 10. If this process is reversed, in particular, if the functional component 50 is attached to the tire 10 first, and a test for examining the uniformity is executed so as to determine the position at which the balance patch 40 should be attached, the attachment position of the balance patch 40 could overlap with the position at which the RFID tag is attached. The manufacturing method according to the present embodiment can avoid such a problem, so as to not only lead the balance patch 40 and the functional component 50 to be separated from each other at a predetermined angle, but also improve the uniformity of the tire 10.

While the present invention has been described above by reference to the embodiment, it should be understood that the present invention is not intended to be limited to the descriptions and the drawings composing part of this disclosure. Various alternative embodiments, examples, and technical applications will be apparent to those skilled in the art according to this disclosure.

For example, the functional component 50 may be arranged at the lightest point of the tire 10. The term “lightest point” refers to a position at which the tire 10 has the lightest weight.

The embodiment has been illustrated above with the case in which the balance patch 40 and the functional component 50 are each arranged in the middle on the tire equator line on the rear side of the tread 20, but is not limited to this case. The balance patch 40 and the functional component 50 only need to be arranged on the tire inner surface 30, and may be arranged on the rear side of the side part, for example.

In view of the operating efficiency in the steps of attaching and removing the balance patch 40, at least a part of the balance patch 40 is preferably located on the tire equator line. Avoiding arranging the functional component 50 on the equator line in this case can further reduce a risk of unintentionally causing damage to the RFID in the step of removing the balance patch 40.

This application is based upon and claims the benefit of priority from Japanese Patent Application No. 2019-109532, filed on Jun. 12, 2019, the entire contents of which are incorporated herein by reference.

### REFERENCE SIGNS LIST

10 PNEUMATIC TIRE
20 TREAD
30 TIRE INNER SURFACE
40, 41, 42 BALANCE PATCH
50 FUNCTIONAL COMPONENT
51 RFID TAG
60 RIM HOLE

1. A pneumatic tire comprising:
at least one balance patch arranged on a tire inner surface that is a surface on an inner side of the tire; and
a functional component having a communication function and arranged on the tire inner surface at a position separated at a predetermined angle from the at least one balance patch in a tire circumferential direction.

2. The pneumatic tire according to claim 1, wherein a gap between the at least one balance patch and the functional component in the tire circumferential direction is longer than a length of the at least one balance patch in the tire circumferential direction.

3. The pneumatic tire according to claim 1, wherein the predetermined angle is 90 degrees or greater when the at least one balance patch is provided at a single position.

4. The pneumatic tire according to claim 1, wherein:
the at least one balance patch comprises a plurality of balance patches; and
the functional component is arranged in a region having a widest gap between the balance patches in the tire circumferential direction.

5. The pneumatic tire according to claim 1, wherein the functional component is lighter than the balance patch.

6. A method of manufacturing a pneumatic tire, comprising:
a first step of arranging at least one balance patch on a tire inner surface that is a surface on an inner side of the tire; and
a second step of arranging a functional component having a communication function on the tire inner surface at a position separated at a predetermined angle from the at least one balance patch in a tire circumferential direction after the first step.
